(19) United States
(12) Patent Application Publication
(10) Pub. No.: US 2009/0243878 A1
(43) Pub. Date: Oct. 1, 2009

(54) Radio frequency transmitter and receiver system and apparatus

(76) Inventors: Camillo Ricordi, Miami, FL (US); Stephen Sanders, San Francisco, CA (US); Steven Sikes, Miami, FL (US)

Correspondence Address: LOEB & LOEB, LLP, 321 NORTH CLARK, SUITE 2300, CHICAGO, IL, 60654-4746, US

(21) Appl. No.: 12/078,479

(22) Filed: Mar. 31, 2008

(51) Int. Cl. G08B 21/00

(52) U.S. Cl. 340/870.16

(57) ABSTRACT

A frequency transmitter and receiver system and apparatus to facilitate communication, care and intervention during critical events. The system communicates either directly or indirectly with medical monitors and sensors, which measure and collect a subject's physiological data and vital signs information. The system communicates with a two-way mobile communication device in order to help facilitate transmission and/or reception of information. When a critical event is detected, a radio frequency transmitter and receiver apparatus can communicate to a two-way mobile communication device that is configured to communicate with the monitor to transmit data and location coordinates of the subject to the service provider, and it initiates a conference call with emergency contacts to facilitate aid to the subject. The radio frequency transmitter and receiver apparatus may include a speaker and GPS technology. It may also include self-activating features wherein critical data are transmitted to the subject and contacts during emergency events.

### CROSS REFERENCE TO RELATED APPLICATIONS

This application references filed U.S. Provisional Application Ser. No. 60/884,219, entitled “A System and Apparatus for Alerting, Location, Tracking, Messaging and Intervention (ALTMI),” filed Jan. 10, 2007, and references filed U.S. patent application Ser. No. 11/938,057, entitled “Mobile Emergency Alert System,” filed Nov. 9, 2007.

### FIELD OF INVENTION

The present invention relates to telemetry monitoring and more specifically to a radio frequency transmitter and receiver system and apparatus that can be utilized, for example, during critical situations and emergency events.

### BACKGROUND

Wireless medical applications are gaining greater popularity with the convergence of networking technologies and advances in vital signs monitoring via bio sensors, implantable devices, RFID, among a plurality of other technologies.

Hundreds of millions of people worldwide with chronic conditions, including but not limited to diabetes, cardiovascular disease, asthma, high blood pressure, and COPD, increasingly are adopting wireless medical applications for disease surveillance, management and control. Moreover, the market for remote patient monitoring is growing to serve individuals with chronic conditions, as well as seniors, an aging society with greater life expectancy, and the aging Baby Boomer generation, as stand-alone medical devices and applications work in tangent with caregivers, medical providers, and emergency response personnel, especially during critical events and acute episodes, such as hypoglycemia, arrhythmia, breathing problems, traumas, falls, and disorientation.

Wireless healthcare technology offers a plurality of advantages, including but not limited, to facilitating communication with individuals and interacting with medical devices, mobile phones, and PDAs, accelerating care, providing cost savings, and increasing the mobility of patients and users. In addition, wireless medical technology is embedded in a plurality of devices, including but not limited to blood pressure sensors and cardiac defibrillators, to send communication and alerts to emergency medical personnel when vital signs measurements reach critical levels. Cardiac monitoring companies like CardioNet offer a device which transmits a user's heart rhythm to a wireless device which transmits the ECG data to a monitoring station. Card Guard, a wireless monitoring company, transmits patient data (including but not limited to blood oxygen, weight and blood pressure) to a monitoring evaluation station.

Individuals utilize a plurality of wireless healthcare applications and devices, and the wireless networking technologies that interact with these applications and devices primarily comprise Wireless Personal Area Networks (WPAN), which support a range of approximately 10 meters (m), and Wireless Local Area Networks (WLAN), which support a range of approximately 150 meters (m). Connectivity technologies within the WPAN include Bluetooth, Zigbee, Radio Frequency Identification (RFID), and Ultra-wide Band (UWB).

A plurality of healthcare providers and initiatives worldwide are utilizing Bluetooth wireless connectivity technology as the global short-range standard, One of the goals of the Bluetooth Special Interest Group ((SIG) is to enhance the healthcare experience through interoperability, wherein users can send vital information to Bluetooth enabled electronic devices including mobile communications devices, cell phones, PDAs, and PCs, during critical situations or for management and surveillance and to share this information in real-time with medical personnel, users' supporters, and selected contacts.

With more advances, increased range for transmission of communication, capability and versatility, wireless technologies are expanding the reach of individual telemetry, such as for healthcare, and they are providing more opportunities to monitor individuals and deliver data in real-time that may be crucial to timely care and quality services. Wireless mobility enhances the freedom of, and provides greater security for individuals, especially those with chronic conditions.

### SUMMARY

An embodiment of the present invention includes a radio frequency transmitter and receiver system, as well as an apparatus that sends communication to a two-way mobile device. In an exemplary embodiment the two-way mobile device transmits stored data to a plurality of emergency contacts to help render assistance quickly, by opening a communication, such as a conference call, with the emergency contacts and the subject over a speaker, or by instructing the selected contacts, based on preference or proximity, to render help or to facilitate intervention.

In an embodiment of the present invention a radio frequency transmitter and receiver apparatus can communicate with a two-way mobile device and employ it to transmit any pertinent data, such as physiological information, medical history, data, location-related coordinates that reside in the memory store of said two-way mobile device.

In some embodiments of the present invention, the radio frequency transmitter and receiver system and apparatus also can include a voice recorder that may capture information made by a subject that has activated said apparatus, and the apparatus may record and subsequently send recorded information to a two-way mobile device for archiving or subsequent transmission to others. Recorded information from the subject may provide details related to mitigating a potentially dangerous situation or critical event involving the subject.

In some embodiments of the present invention, the radio frequency transmitter and receiver system and apparatus also can include one or more sensors for measuring physiological data and/or information.

In some embodiments of the present invention, the radio frequency transmitter and receiver system and apparatus also can include a speaker that may wirelessly receive communication from a two-way mobile device for transmission to a subject via said radio frequency transmitter and receiver system.

In certain embodiments of the present invention, the two-way mobiles communication device may be a mobile communication device; e.g., a cell phone, configured to interface with the medical monitor. The two-way mobile communication device also may be a cellular phone and a proxy device. The proxy device could be configured to facilitate communication between the e.g. mobile phone and a medical monitor, sensor or transmitter.

### BRIEF DESCRIPTION OF THE DRAWINGS

FIG. 1 is a block diagram of an exemplary system in which embodiments of the present invention can operate.

FIG. 2 is an overview flow chart of an exemplary process in accordance with an illustrative embodiment of the present invention.

FIG. 3 is an overview flow chart of another exemplary process in accordance with an illustrative embodiment of the present invention.

FIG. 4 is an overview flow chart of another exemplary process in accordance with an illustrative embodiment of the present invention.

FIG. 5 displays some of the elements in a radio frequency transmitter and receiver system and apparatus in accordance with an illustrative embodiment of the present invention.

FIG. 6 displays some of the elements in radio frequency transmitter and receiver system and apparatus in accordance with an illustrative embodiment of the present invention.

### DETAILED DESCRIPTION

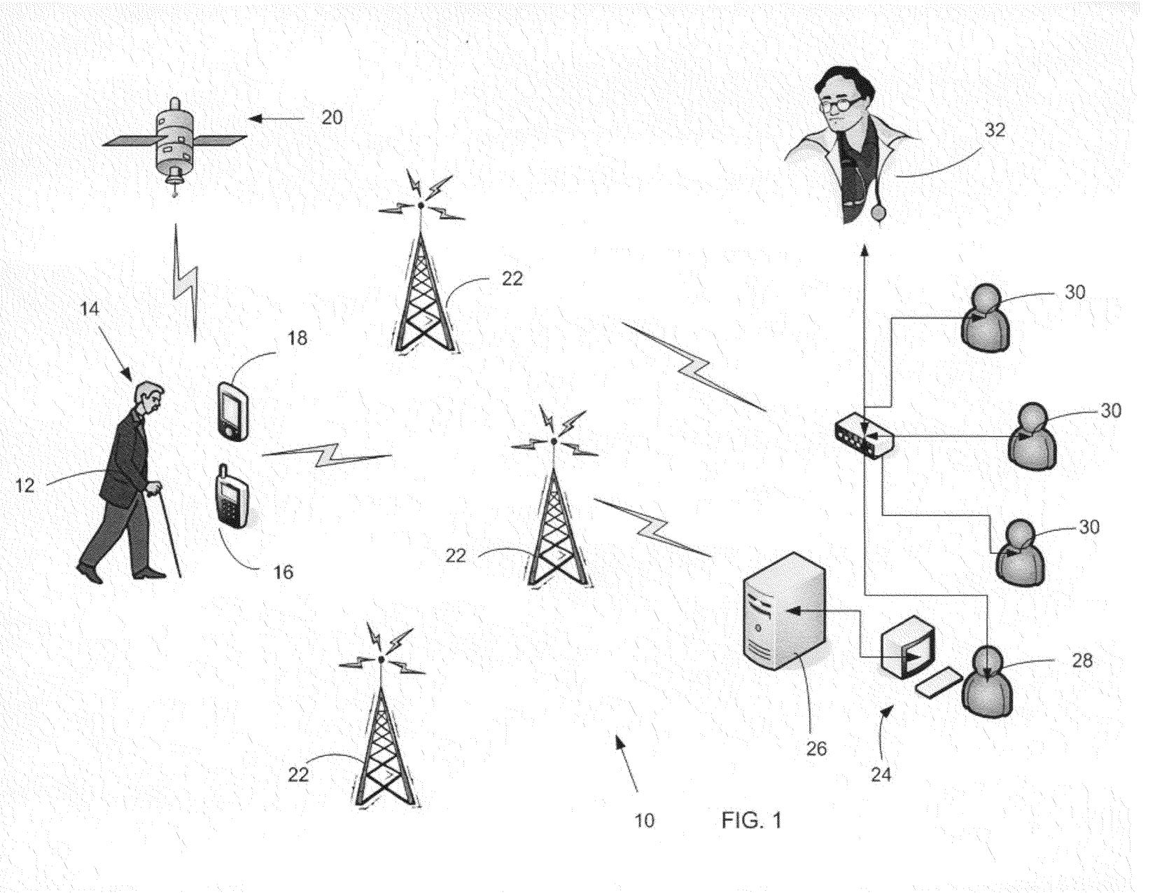

As shown in FIG. 1, a mobile emergency alert system 10 in accordance with an illustrative embodiment of the present invention can include a monitor 12, which can be a medical monitor worn by a subject 14. The subject can be, for example, a person, a patient, an athlete, or any other user, such as a senior citizen or individual with a chronic condition, to be monitored. The medical monitor or biosensor 12 can measure, for example, the subject's desired physical attribute, for example blood sugar levels, and it subsequently communicates any abnormal or dangerous levels to an Alerting, Locating, Tracking, Messaging and Intervention Device (“ALTMI”) 16 carried by the subject 14. The ALTMI 16 is a two-way mobile communication device (i.e., capable of sending and receiving information and/or data). An example of the ALTMI 16 includes but is not limited to a mobile telephone, configured to communicate with the medical monitor 12. The medical monitor 12 may be any type of medical monitor or sensor used to measure physiological data. The medical monitor 12 and ALTMI 16 may communicate by wireless technology, such as Bluetooth. The ALTMI 16 may also be capable of being located by a global positioning system (“GPS”) 20 or by triangulation from various cellular towers 22.

The ALTMI 16 may be a separate device, such as the mobile phone described above, or it may be an integral part of the medical monitor 12. Further, the ALTMI 16 may be two separate components configured to communicate with the medical monitor 12. For example, the ALTMI 16 may be a two-way mobile communication device, such as the mobile phone, and a proxy device to enable the two-way mobile communication device to communicate with the medical monitor 12. In such a configuration, the proxy device works as a translator between the two-way mobile communication device and the medical monitor 12. The proxy device enables greater flexibility to use, for example, any mobile phone with any medical monitor 12 by structuring the proxy device to communicate with both, e.g., via hardware, software or a combination of both.

A radio frequency transmitter and receiver device (“RFTR”) 18 can also be included in accordance with an illustrative embodiment of the present invention. As an example, the RFTR 18 can be carried by, or positioned within operating range of the subject 14. The RFTR 18 can be a mobile communication device (i.e., capable of sending and receiving information and/or data), such as a mobile phone, configured to communicate with the ALTMI 16. The RFTR 18 may be used by the subject 14 to communicate to the ALTMI 16. For example, in accordance with an illustrative embodiment of the present invention, the RFTR 18 can be a device or tool such as a pendant, bracelet or pager. In this example, the user can cause the RFTR 18 to contact the ALTMI 16 by pushing a button to initiate the process of communication with a service provider. Either the RFTR 18 or the ALTMI 16 may initiate contact with each other and begin the process of transmission and/or reception of data including but not limited to text, software commands, software updates, voice, or video. The RFTR 18 and ALTMI 16 may communicate by wireless technology, including but not limited to Bluetooth and Zigbee. The RFTR 18 may also be capable of being located by a global positioning system (“GPS”) 20 or by triangulation from various cellular towers 22. The RFTR 18 may be able to transmit its longitude and latitude coordinates to the ALTMI 16. The RFTR 18 may be able to record data upon activation, including but not limited to voice, and transmit said data to the ALTMI 16, for archiving or subsequent transmission. The medical monitor 12 or a plurality of medical monitors 12 may be either separate or combined with the RFTR 18. The RFTR 18 may contain one or more medical monitors 12 or may not contain one or more medical monitors 12, but instead communicate with the one or more medical monitors 12 wirelessly or via hardwire (including any software needed to operate such hardware).

The ALTMI 16 can send information obtained by the medical monitor 12, for example physical parameters measured by the medical monitor 12, and the ALTMI 16, such as location coordinates from the GPS 20, via the cellular towers 22 to a service provider 24 that houses the subject's database 26, such as a health or emergency-response related database. The subject's medical history database 26 can include, for example, the subject's medical records and emergency contact list. The subject's medical or emergency response database 26 may also reside on the ALTMI 16. When a critical event is detected, the service provider 24 can open a conference call and initiate communication. The communication may include a plurality of individuals, which may include a representative of the service provider 28, emergency contacts 30 and a telecare provider 32, such as a physician or nurse, as is more fully explained below.

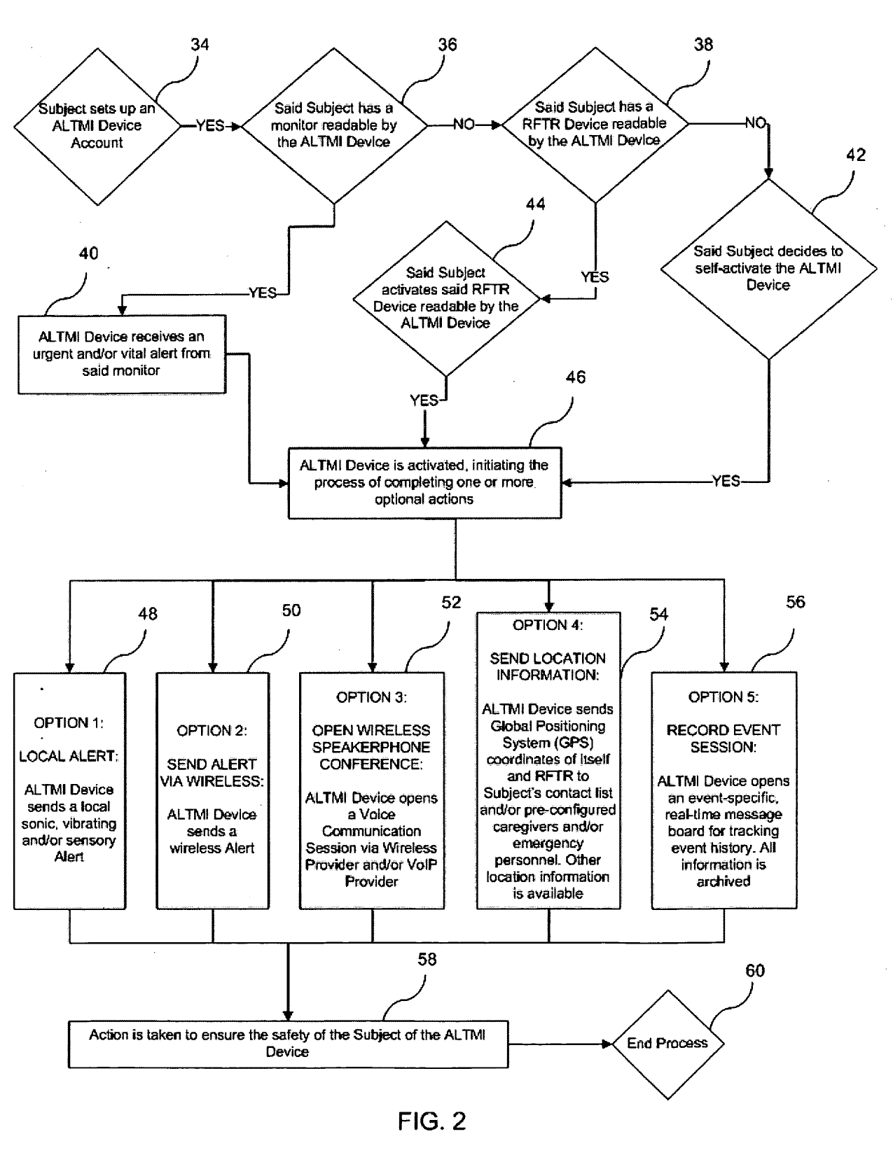

Referring now to FIG. 2, in accordance with an illustrative embodiment of the present invention, a subject 14 sets up an ALTMI account (34). The ALTMI account can allow the subject to create an emergency contact list. The emergency contact list may include anyone, but preferably, it includes a physician, a representative of the service provider, a telecare provider, and emergency care personnel, and these contacts could comprise a caregiver, a colleague, a travel partner, a spouse, a child, a family member, a neighbor, and/or a friend who is nearby, contacts which may updated by the user based on preference or proximity. FIG. 2 is an overview flow chart of an exemplary process in accordance with an illustrative embodiment of the present invention. As shown in FIG. 2, in one exemplary process, when the medical monitor 12 indicates that the subject's 14 measured physical attributes are within a predetermined, emergency condition, the medical monitor 12 sends a signal. If the subject 14 has a medical monitor 12 that is readable by the ALTMI 16 (36), then the ALTMI 16 may receive an urgent and/or vital alert from the medical monitor 12 (40). If the subject 14 has a RFTR 18 readable by the ALTMI 16 (38), and the subject activates (e.g., by pushing a button) the RFTR 18 readable by the ALTMI 16 (44) then the ALTMI 16 is activated, initiating the process of completing one or more optional actions (46). If the medical monitor 12 is not readable by the ALTMI 16, then the subject 14 may self-activate the ALTMI 16 (42). Once the ALTMI 16 is activated, the ALTMI 16 initiates one or more optional actions (46). For example, one option action (48) may include a local alert in which the ALTMI 16 sends a local audible, vibrating and/or other sensory alert. A second option action (50) may include the ALTMI 16 sending a wireless alert. A third option action (52) may include opening a wireless speakerphone conference call in which the ALTMI 16 opens a voice communication session on either the ALTMI 16, the RFTR 18, or both via a wireless provider or Voice over Internet Protocol (“VoIP”). This initiation of the conference call may be accomplished automatically or by a service provider representative. A fourth option action (54) may include sending location information, such as GPS coordinates, from the ALTMI 16 and/or from the RFTR 18 to a representative of the service provider 28, the subject's emergency contacts 30 and/or the telecare provider 32. A fifth option action (56) may include recording data from the medical monitor 12 to track and monitor the critical event. To record the data, the ALTMI 16 may open an event-specific real-time message board to track the critical event history and archive the data. After one or more of the option actions occur, action is taken to ensure the safety of the subject 14 (58), and the process is thereafter ended (60).

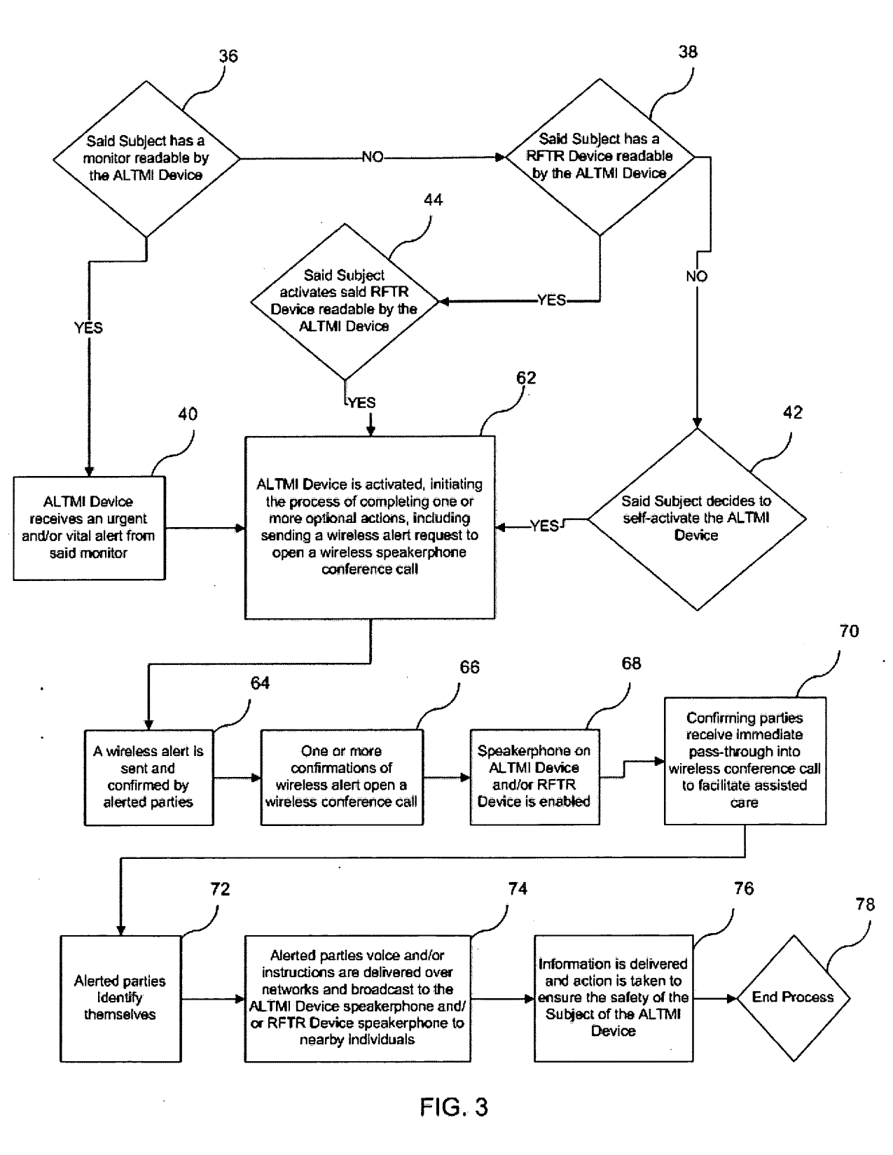

FIG. 3 is an overview flow chart of another exemplary process in accordance with an illustrative embodiment of the present invention. Referring now to FIG. 3, if the subject 14 has a medical monitor 12 that is readable by the ALTMI 16 (36), then the ALTMI 16 may receive an urgent and/or vital alert from the medical monitor 12 (40). If the medical monitor 12 is not readable by the ALTMI 16, then the subject 14 may self-activate the ALTMI 16 (42). If the subject 14 has a RFTR 18 readable by the ALTMI 16 (38), and the subject 14 activates the RFTR 18 readable by the ALTMI 16 (44), then the ALTMI 16 is activated. Once the ALTMI 16 is activated, the ALTMI 16 can initiate one or more optional actions, including sending a wireless alert request to open a call, such as a wireless speakerphone conference call (62). An alert is sent and confirmed by the alerted parties (64), which may include a representative of the service provider 28, the subject's 14 emergency contacts 30 and/or a telecare provider 32. One or more confirmations of the alert, in one embodiment, results in the opening of the wireless conference communication (66), (e.g., a speakerphone call), and the speakerphone on the ALTMI 16 and/or on the RFTR 18 is enabled (68). Each of the confirmed parties receives access into the wireless conference call to facilitate assistance to or for the subject 14 (70). The alerted parties can identify themselves (72) and provide information and instructions to each other, to the subject 14 and/or any nearby individuals, which is broadcast to the ALTMI 16 speakerphone and/or the speakerphone of the RFTR 18 (74). The information and instructions are thus delivered and necessary can be taken to ensure the safety and well-being of the subject 14 (76). For example, if the subject 14 has a critical event in the subject's backyard, and one of the emergency contacts 30, such as a spouse or child, is in the house, medical assistance may be administered. Further, the telecare provider 32 can guide the emergency contact 30 to facilitate appropriate medical treatment. If the subject requires further assistance, such as transportation to a nearby medical facility or care by an EMT, the telecare provider 32 may direct the representative of the service provider 28 and for the dispatch of an ambulance or emergency transportation vehicle, including but not limited to an ambulance or med-vac. Because all the alerted parties are on a conference call, the necessary steps can be discussed and implemented quickly, without leaving the subject 14 or the conference call. Once the safety and well-being of the subject 14 has been addressed, the process is ended (78).

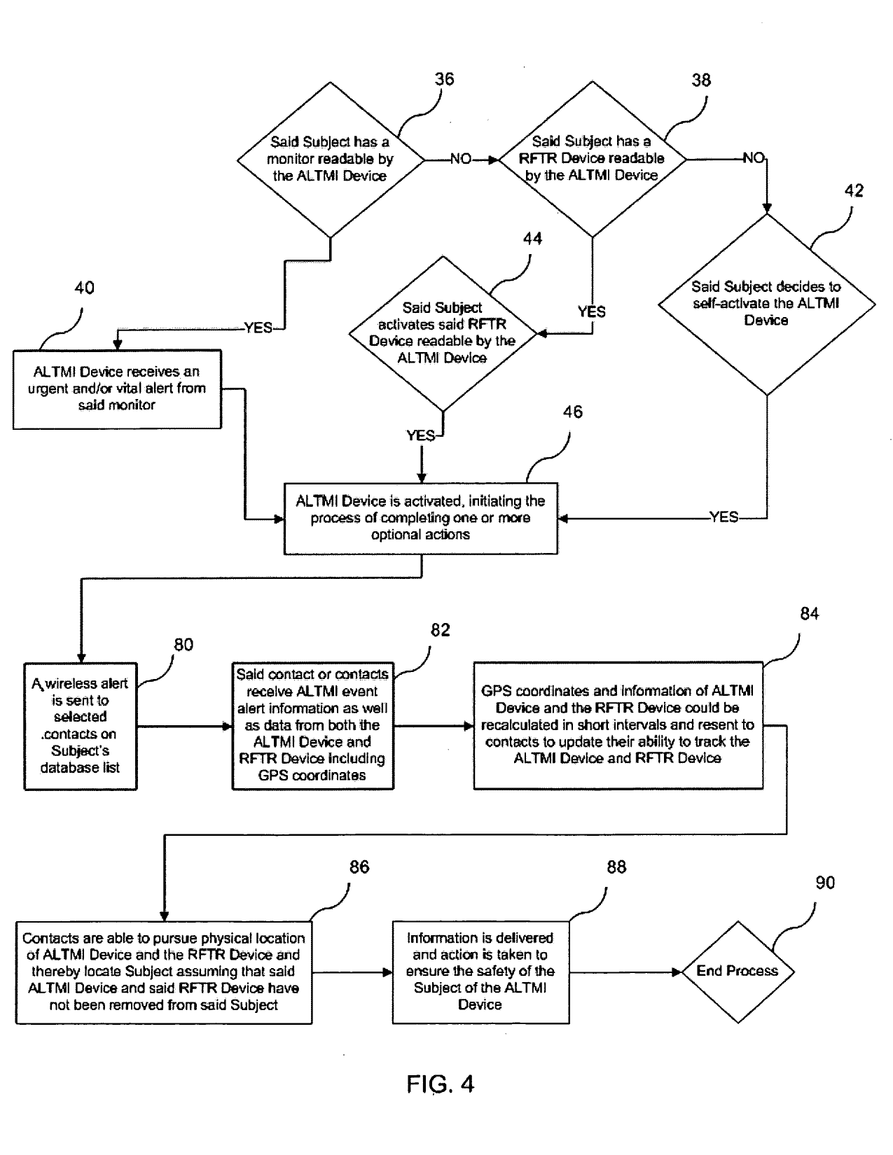

FIG. 4 is an overview flow chart of another exemplary process in accordance with an illustrative embodiment of the present invention. Referring now to FIG. 4, as described above, once the ALTMI 16 is activated; the ALTMI 16 can initiate one or more optional actions (46). One option may be to send a wireless alert to emergency contacts 30, selected from the subject's medical database 26 (80). The emergency contacts 30 may include one or more individuals, organizations, or entities. The selected emergency contacts 30 may be selected based on various criteria, such as, for example, the time of day, location, preference or expertise. For example, some emergency contacts 30 may be co-workers, and would be selected if an emergency occurs during business hours. Some emergency contacts may be neighbors, and would be selected based on proximity of the user. Some emergency contacts may be selected when the subject 14 travels, as described above. The selected emergency contacts 30 receive an alert from the ALTMI 16, as well as data from both the ALTMI 16 and RFTR 18. Such data can include, for example, location information, such as GPS 18 coordinates, and medical information (82). The location and medical information may be recalculated in short intervals and resent to the selected emergency contacts 30 to update the ability to track the ALTMI 16 and the RFTR 18, and thus the subject 14, when the subject 14 is mobile (84). The selected emergency contacts 30 are thus able to pursue the real-time physical location of the subject 14 (86). Once the subject 14 has been located, the information is delivered and used as described above to ensure the safety of the subject 14 (88). Once the safety and well-being of the subject 14 has been ensured, the process is ended (90).

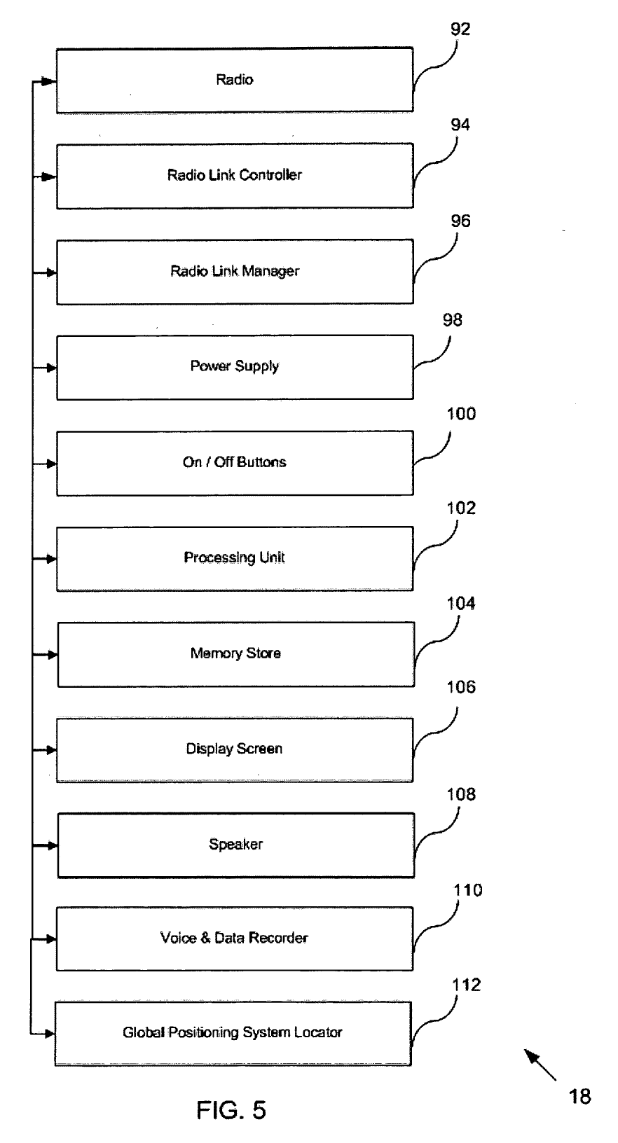

FIG. 5 displays some of the elements in a radio frequency transmitter and receiver system and apparatus in accordance with an illustrative embodiment of the present invention. Referring now to FIG. 5 an embodiment of an RFTR 18 in accordance with the present invention may include, for example: a radio 92 for communication to the ALTMI 16; a radio link controller 94 for controlling the connectivity of the radio 94; a radio link manager 96 to manage the radio link; a power supply 98 to provide power; on and off buttons 100 for activating and deactivating the RFTR 18; a processing unit 102 for processing the transmission, reception and storage of data; a memory store 104 for archiving data, including but not limited to voice, physiological and GPS 20 data; a display screen 106 to provide a graphical display for the subject 14 and others; a speaker 108 for amplifying voice and other sounds; a voice and data recorder 110 for capturing voice and other data; and a global positioning system locator 112 to facilitate locating the RFTR 18. Other elements may be included including but not limited to a GPS 20 chip or transmitter.

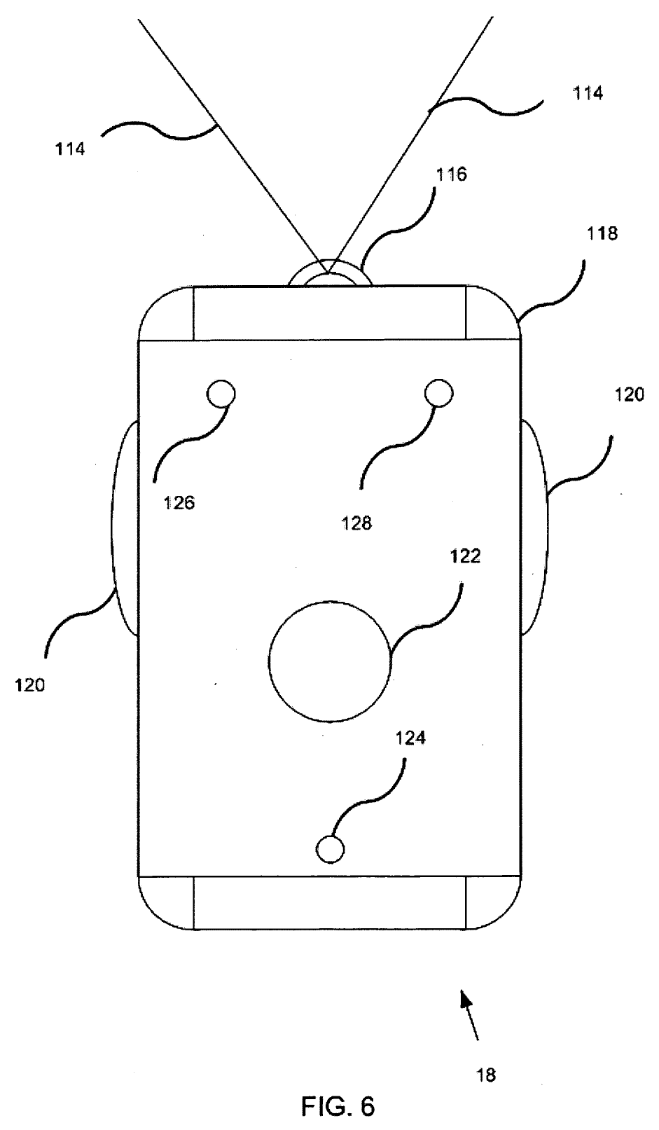

FIG. 6 displays some of the elements in radio frequency transmitter and receiver system and apparatus in accordance with an illustrative embodiment of the present invention. Referring now to FIG. 6 is noted that the shape of the radio frequency transmitter and receiver device (RFTR) 18 may vary and can include shapes including but not limited to that of a pendant, necklace, belt buckle, watch, key chain, fob, dongle, or other devices, both wearable or non-wearable. Some of the basic elements of the RFTR 18 may include but not be limited to the following items. A body 118 may be supplied which in this depiction is shaped as a wearable pendant. A body fastener link 116 may be supplied to allow the RFTR 18 to fasten to a user or to items near the user. A body fastener 114 may be supplied, such as an item including but not limited to a cord or a chain to facilitate fastening the RFTR 18 to an item or user. One or more “on” buttons 120. As depicted here, both the “on” buttons 120 must be depressed in order to activate the RFTR 18, so as to avoid accidental activation of the RFTR 18, in the case that only one of the “on” buttons is depressed and the other the “on” button 120 is not depressed. The one or more “on” buttons 120 may be configured in several ways including but limited to protruding from the body 118, flat in line with the body 118, or recessed inside of the body 118. The one or more “on” buttons 120 may be recessed in the body 118 so as to reduce the probability of accidental activate of the RFTR 18. By employing more than one “on” button 120, such as using two “on” buttons 120 as opposed to one, and by recessing the two “on” buttons 120, the probability of accidental activation of the RFTR 18 is reduced An “off” button 122 to turn off the activation of the RFTR 18, or to power down the RFTR 18 may be provided and may also protrude from, align flat with or be recessed inside of the body 118 A display indicator 124, including but not limited to a LED-style light that may display various colors including but not limited to green, yellow and red, to display various sates of the RFTR 18 including but not limited to low battery, fully charged, reading a signal from a paired device, and/or not reading a signal from a paired device. A speaker 126 for playing sound and other acoustic signals, including but not limited to voice and alarms sounds. A receiver 128 for detecting and capturing information including but not limited to voice.

It is to be understood that the foregoing description is intended to illustrate and not to limit the scope of the invention, and that the RFTR 18 may be configured in a various ways including but not limited to, being either physically separate from, or combined with the ALTMI 16 and/or one or more medical monitors 12. Moreover, the RFTR may also communicate with one or more of mobile devices including but not limited to an ALTMI device, by broadcasting a wireless signal to said mobile devices that are within range. It is also to be understood that the foregoing description is intended to illustrate and not to limit the scope of the invention, which is defined by the scope of the appended claims. Other embodiments are within the scope of the following claims.

1. A system for communicating with a service provider comprising:
a monitor configured to detect at least one parameter and to provide data indicative of the at least one parameter;
a mobile communication device configured to communicate with and to receive the data indicative of the at least one parameter from the monitor, to communicate with a service provider in response to a communication from the monitor

2. The system according to claim 1, further comprising:
a radio frequency transmitter and receiver device configured to communicate with the mobile communication device, and wherein the a mobile communication device is further configured to initiate communication with the service provider in response to a communication from the radio frequency transmitter and receiver device.

3. The system of claim 1 wherein the radio frequency transmitter and receiver device is, configured to initiate a communication with the mobile communication device in response to an input to the radio frequency transmitter and receiver by a person.

4. The system of claim 3 wherein the radio frequency transmitter and receiver system and apparatus is configured to send global positioning system coordinates to the mobile communication device.

5. The system of claim 1 wherein the mobile communication device is configured to send and receive global positioning system information.

6. The system of claim 3 wherein the input to the radio frequency transmitter and receiver apparatus comprises a voice.

7. The system of claim 1 wherein the radio frequency transmitter and receiver apparatus is configured to display information received from the two-way mobile communication device, including but not limited to information on, contacts, service provider information, and physiological data.

8. The system of claim 5 wherein the mobile communication device is further configured to provide at least-one of global positioning system coordinates and mobile telephone triangulation information.

9. A method of rendering aid comprising:
monitoring and collecting physiological data;
receiving the physiological data to enable accessing a database; and
initiating a conference call between the subject and at least one emergency contact from the emergency contact list when a critical event is detected.

10. The method of claim 9 further comprising transmission of the physiological data.

11. The method of claim 10 wherein the transmission of the physiological data is manually initiated.

12. The method of claim 11 wherein the manual initiation includes two manual operations.

13. The method of claim 12 wherein the two manual operations are sequential.
